(19) United States
(12) Patent Application Publication
(10) Pub. No.: US 2017/0200286 A1
(43) Pub. Date: Jul. 13, 2017

(54) System and method for creating and placing a collection of personalized products on a surface

(71) Applicant: Shutterfly, Inc., Redwood City, CA (US)

(72) Inventors: Syed Saleem Javid Brahmanapalli, Dublin, CA (US); Stephanie Tang, San Francisco, CA (US); Justin Gaerlan, Foster City, CA (US); Kobi Avriel, Sunnyvale, CA (US); Romeo Gotera, South San Francisco, CA (US); Kristin Sardina, Sausalito, CA (US)

(21) Appl. No.: 15/354,321

(22) Filed: Nov. 17, 2016

Related U.S. Application Data
(63) Continuation-in-part of application No. 15/234,399, filed on Aug. 11, 2016.
(60) Provisional application No. 62/277,836, filed on Jan. 12, 2016.

(51) Int. Cl. G06T 7/60; A47G 1/16; H04N 7/18; G06T 7/40; H04N 5/232

(52) U.S. Cl. CPC G06T 7/602; G06T 7/408; H04N 5/23293; H04N 7/183; A47G 1/16; G06T 2207/10024; G06T 2207/10004; G06T 2210/04

(57) ABSTRACT

System and method are disclosed for decorating a surface with a collection of personalized products. The disclosed method assists designers to choose personalized product types, to pick photos for the personalized products, to create the personalized products, and to place the multiple personalized products on the surface. Designers can preview the personalized products in correct proportions in the intended environment before the personalized products are manufactured.

### TECHNICAL FIELD

This application relates to decorating a home or a business environment, and more specifically, to creation and display of personalized products.

### BACKGROUND OF THE INVENTION

Digital images can be stored in user's computers and viewed on electronic display devices. The proliferation of mobile devices such as camera phones and tablet computers has enabled an increasing number of users to take pictures, share photos, post photos online, and create personalized products or projects.

Users can upload digital images to a central network location provided by image service providers such as Shutterfly, Inc. The image service providers can enable users to store, organize, manage, edit, enhance, and share digital images at the central network location using a web browser or other software applications. A user can also design and personalize products, and order these products from the image service provider. Examples of the personalized products include image prints, photo books, photo calendars, photo greeting cards, holiday cards, photo stationeries, photo mugs, and photo T-shirts, which incorporate image content provided by the user or the image service provider. Other examples of personalized products include glassware, tiles, woodwork, jewelry trays, paperweights, pillows, and mugs that include customizable graphic designs, text, or images.

Many personalized products can be displayed for decorations at home or in a business or commercial surrounding. These products can include framed photo prints, posters, calendars, banners, fabrics, pictures printed on canvas, pictures printed on a scroll, etc., which can be displayed on the surface of a wall. Several personalized products are often placed in a group to achieve desirable decorative effects.

Creating personalized products, however, can take considerable amount of time and effort. Designing multiple personalized products for decorating a room takes extra effort. Designers not only have to pick the right photos and the desirable personalized products; they also have to consider the dimensions and geometries of the available display area (e.g. on a wall), the sizes of the personalized products, and the overall visual effects of the personalized products as a group and compatible with the environment.

There is therefore a need for convenient methods and tools to assist designers to create personalized products for the purpose of displaying them in a specific environment.

### SUMMARY OF THE INVENTION

System and method are disclosed for decorating a surface with personalized products. The disclosed method assists designers to choose personalizable product types, to pick or create images, text, or designs for the personalized products, to create the personalized products, and to place the personalized products on a surface. The surface can include a display area on a wall. Users can preview the personalized products in correct proportions in the intended display environment before the personalized products are manufactured.

In one general aspect, the present invention relates to a method for automatically creating design for a collection of personalized products in a display area, which includes: capturing an image of a display area and an anchor on a surface by a first computer device, wherein the anchor has a known dimension; automatically identifying the anchor on the surface; automatically calculating dimensions of the display area using the known dimension of the anchor and relative dimensions of the display area and the anchor in the image on the first computer device; automatically suggesting a collection of personalized products to be placed in the display area based on the dimensions of the display area and sizes of the personalized products; and displaying the collection of personalized products in the display area on the surface on the first computer device.

Implementations of the system may include one or more of the following. The first computer device can retrieve the known dimension from a computer storage in response to the step of identifying the anchor on the surface. The known dimension of the anchor can be received from a user by the first computer device. The anchor can define location of the display area on the surface. The method can further include displaying a virtual border around the display area on the first computer device, wherein the collection of personalized products is displayed within the virtual border on the first computer device. The method can further include automatically suggesting types for the personalized products to be placed in the display area based on the dimensions of the display area and sizes of the personalized products. The types of the personalized products to be placed in the display area can be automatically selected in part based on a color or a texture of the surface. The method can further include automatically creating designs of the personalized products to be placed in the display area in part based on the dimensions of the display area and sizes of the personalized products. The designs of the personalized products can be automatically created in part based on a color or a texture of the surface. The method can further include automatically selecting photos to be incorporated in the personalized products to be placed in the display area. The photos to be incorporated in the personalized products can be automatically selected in part based on a color or a texture of the surface. The method can further include storing a layout of the collection of personalized products in the display area on the first computer device. The method can further include manufacturing physical personalized products based on the collection of personalized products to be placed in the display area; and guiding placements of the physical personalized products on the surface comprising the steps of: capturing a live image of the display area on the surface using a second computer device; displaying the layout of the collection of personalized products in the display area on the second computer device; and placing each of the physical personalized products in the display area on the surface based on locations of the respective personalized products in the layout. The known dimension can be a width of the anchor, wherein a width of the display area can be automatically calculated using the known dimension of the anchor multiplied by a ratio of a width of the display area to a width of the anchor in the image on the first computer device. The known dimension can be a height of the anchor, wherein a height of the display area can be automatically calculated using the known dimension of the anchor multiplied by a ratio of a height of the display area to a height of the anchor in the image on the first computer device. The first computer device can include a mobile phone, or a tablet computer, or a laptop computer or a desktop equipped with or connected to a camera.

These and other aspects, their implementations and other features are described in detail in the drawings, the description and the claims.

### BRIEF DESCRIPTION OF THE DRAWINGS

FIG. 1 illustrates a conventional web user interface that assists a designer to choose and place personalized products on a wall for decoration purpose.

FIG. 2 is a block diagram of a network-based system for producing personalized products, image designs, or image projects compatible with the present invention.

FIG. 3A is a perspective view illustrating viewing layout and measuring dimensions of a display surface, and choosing and placing personalized products using a first computer device in accordance with the present invention.

FIG. 3B illustrates a computer user interface on a second computer device for creating and choosing personalized products, and placing these products on the layout of a display surface captured by the first computer device in accordance with the present invention.

FIG. 4 is a flowchart for assisting a user to choose and create personalized products and place these personalized products in correct proportions on a surface in accordance with one aspect of the present invention.

FIG. 5 is a flowchart for assisting a user to choose and create personalized products and place these personalized products in correct proportions on a surface in accordance with another aspect of the present invention.

FIG. 6A is a perspective view illustrating capturing an image of a display surface using a first computer device in relation to FIG. 5.

FIG. 6B illustrates a user interface on a second computer device that displays the display surface and personalized products on the display surface in relation to FIGS. 5 and 6A.

### DETAILED DESCRIPTION OF THE INVENTION

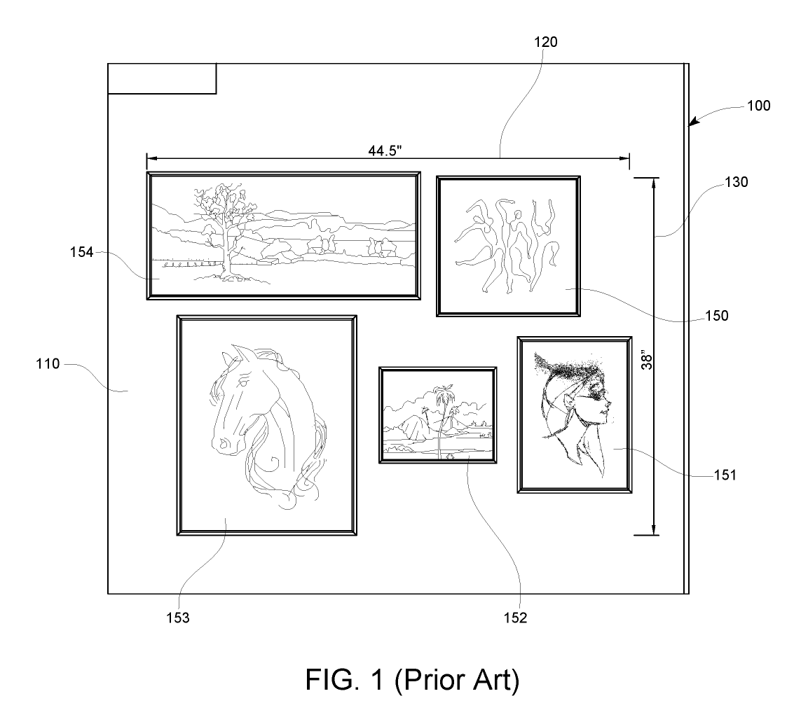

Today, companies like Shutterfly, Inc. provide tools to assist users to create personalized products to be displayed on a surface in a home or business environment. Users are asked to measure out the dimensions (e.g. 44.5″ by 33″) of the areas. In the product creation path, as shown in FIG. 1, a browser 100 can indicate the width and the height of the display area 110 by lines 120, 130 with end arrows in a blank background, which serves an approximation of the real wall. The user can place personalized products 150-154 within the approximate display area 110 indicated by lines 120, 130 and the arrows.

There are several drawbacks associated with the existing tools that assist users to designing a wall with display of personalized products. Firstly, users have to make the measurements of the wall themselves. Secondly, the users can only imagine what the final display of the personalized products might look like. There is no realistic preview of the personalized products in a particular environment.

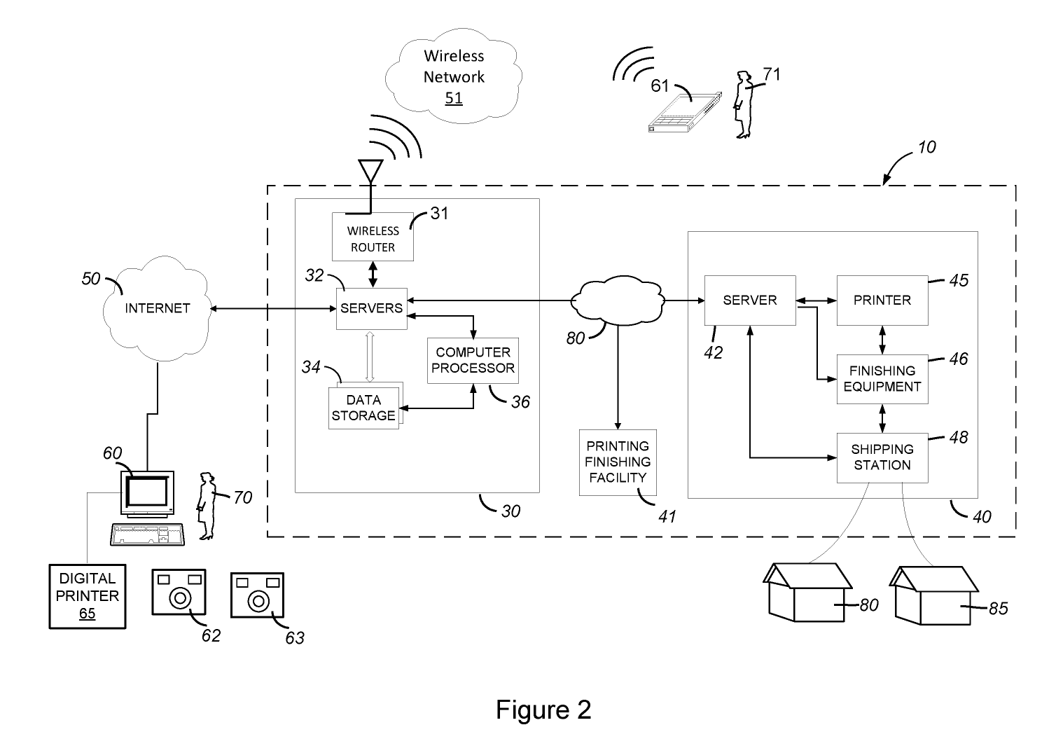

In accordance with the present invention, a system and a method are disclosed to improve user experience, improve dimensional accuracy, and reduce the amount of time for users to design and decorate personalized products on a wall. Referring to FIG. 2, a network-based imaging service system 10 enables users 70, 71 to organize and share images via a wired network or a wireless network 51. The network-based imaging service system 10, operated by an image service provider such as Shutterfly, Inc., can fulfill personalized products ordered by users 70, 71. The personalized products can include personalized photos, text, or designs. The network-based imaging service system 10 includes a data center 30, one or more product fulfillment centers 40, 41, and a computer network 80 that facilitates communications between the data center 30 and the product fulfillment centers 40, 41.

The data center 30 includes one or more servers 32 for communicating with devices (60, 61) owned by users 70, 71, a data storage 34 for storing user data, image and design data, and product information, and computer processor(s) 36 for rendering images and product designs, organizing images, and processing orders. The user data includes account information, discount information, and order information associated with the user. A website can be powered by the servers 32 and can be accessed by the user 70 using a computer device 60 via the Internet 50, or by the user 71 using a wireless device 61 via the wireless network 51. The servers 32 can also support a mobile application to be downloaded onto wireless devices 61.

The network-based imaging service system 10 provides tool for users to design and personalize products. In the present disclosure, the term “personalized” (or “individualized” or “customized”) refers to content that is specific to the recipient, the user, the gift product, and the occasion, which can include personalized text, personalized images, or personalized designs or colors. Examples of personalized products may include photobooks, personalized greeting cards, photo stationeries, photo or image prints, photo posters, photo banners, photo playing cards, photo T-shirts, photo mugs, photo aprons, or magnets, mouse pads, a phone case, a case for a tablet computer, key-chains, photo collectors, coasters, banners, or other types of photo gifts that include personalized content. The term photobook generally refers to as bound multi-page product that includes at least one image on a book page. Photobooks can include image albums, scrapbooks, bound photo calendars, or photo snap books, etc. A personalized product can include a single page or multiple pages. Each page can include one or more images, text, and design elements. Some of the images may be laid out in an image collage. Moreover, a collection personalize photo or image products can be designed in a coherent layout to be displayed on surfaces (e.g. walls, doors, etc.) for decorations at home or in a business or commercial surrounding.

The user 70 or his/her family often owns multiple cameras 62, 63 including mobile phones with built-in cameras, digital cameras, a video camera, and computers with built-in cameras. The user 70 transfers images from cameras 62, 63 to the computer device 60 (e.g. a personal computer, a laptop, or tablet computer, a mobile phone, etc.) on which the images can be edited and organized.

Images in the cameras 62, 63 are stored on the computer device 60 and the wireless device 61 can be uploaded to the server 32 to allow the user 70 to organize and render images at the website, share the images with others, and design or order a personalized product incorporating the images. The pictures on the wireless device 61 can be uploaded to the data center 30. If users 70, 71 are members of a family or a group (e.g. a soccer team), the images from the cameras 62, 63 and the mobile device 61 can be grouped together to be incorporated into a personalized product such as a photobook, or used in a blog page for an event such as a soccer game.

The users 70, 71 can order a physical product based on the design of the personalized product, which can be manufactured by the printing and finishing facilities 40 and 41. A recipient receives the physical product with messages from the users at locations 80, 85. The recipient can also receive a digital version of the design of the personalized product over the Internet 50 and/or a wireless network 51. For example, the recipient can receive, on her mobile phone, an electronic version of the greeting card signed by handwritten signatures from her family members.

The images or videos stored in the data storage 34, the computer device 60, or the mobile device 61 usually include groups of photos or videos taken at different events and occasions.

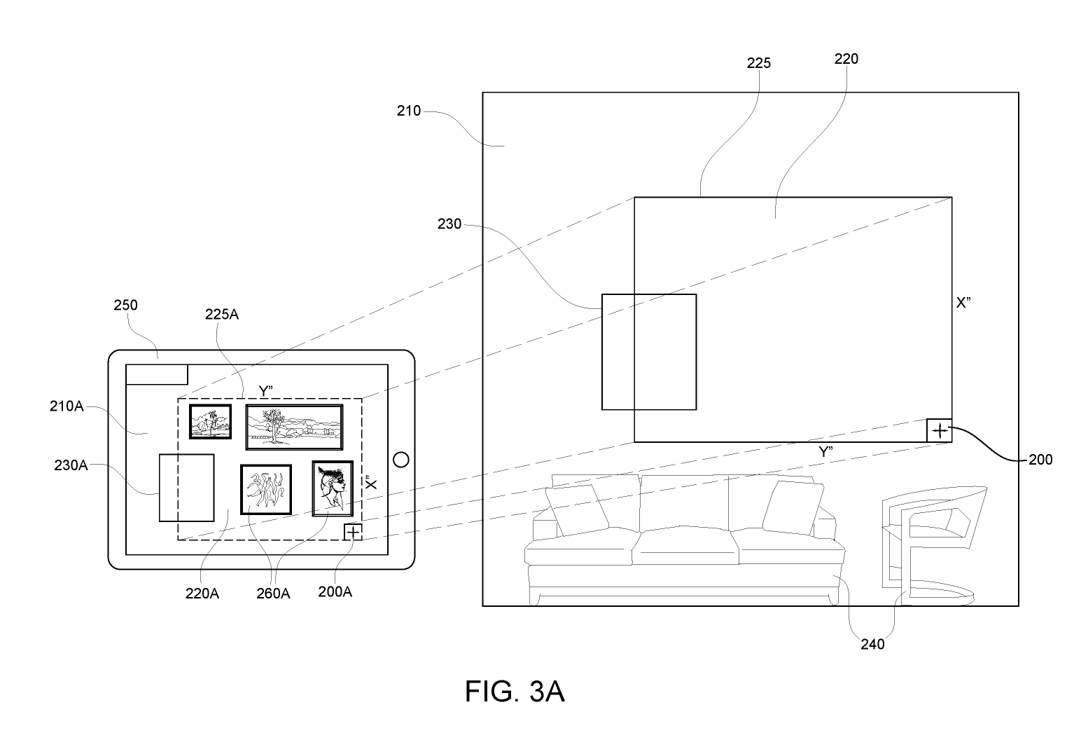

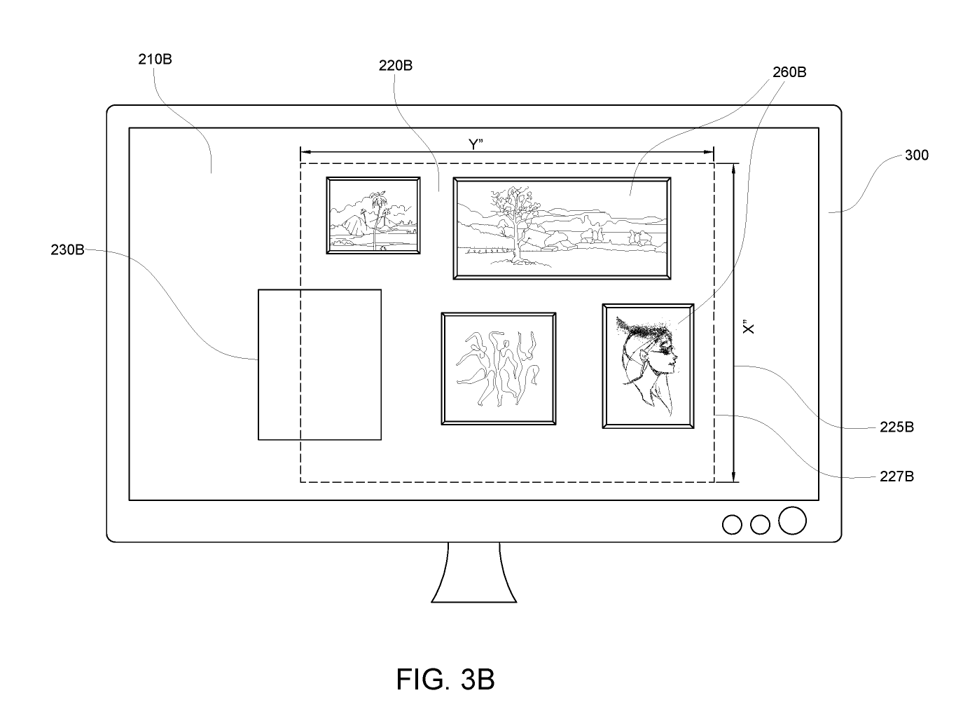

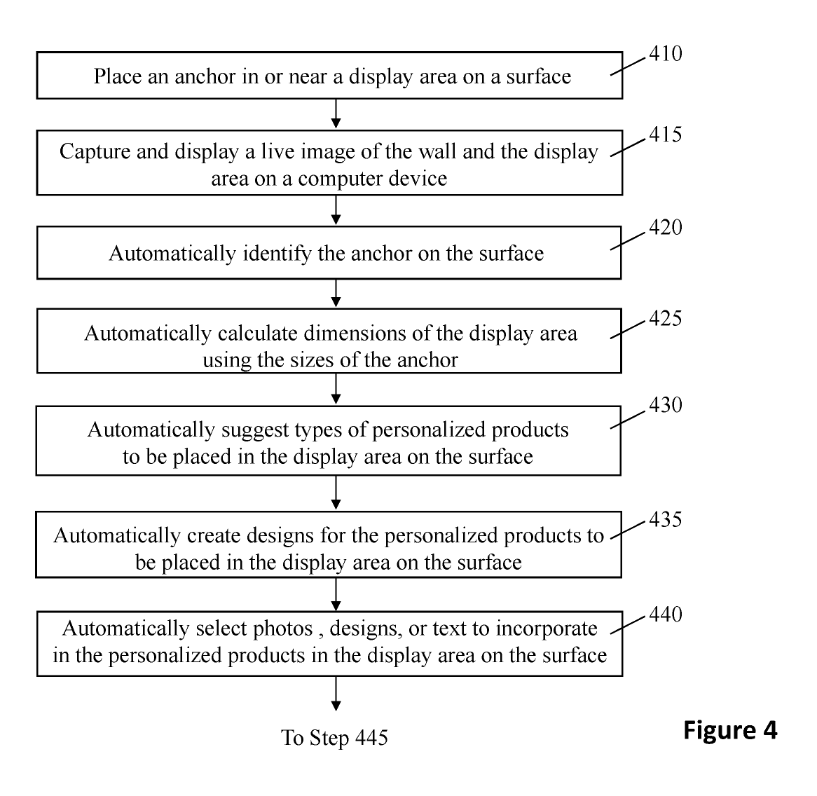

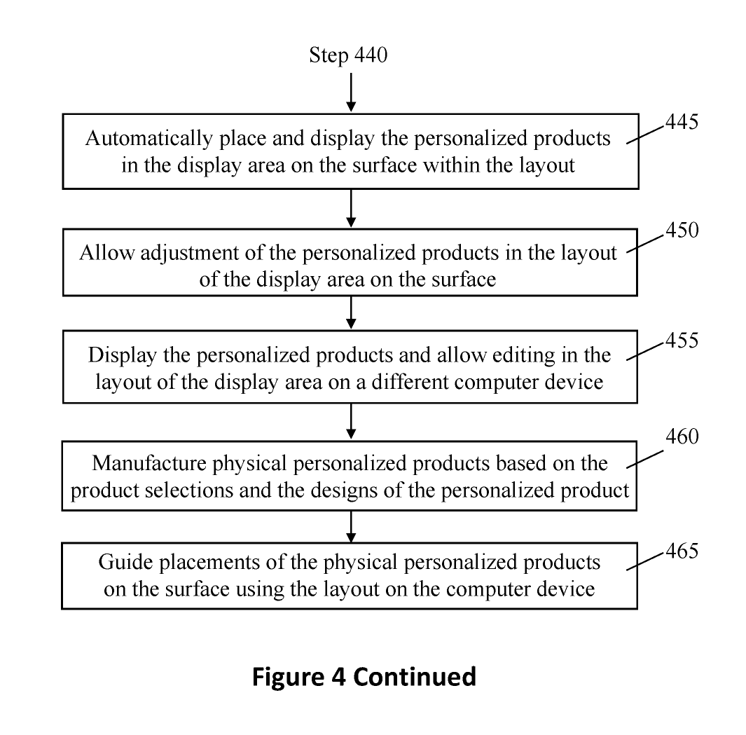

To improve user experience, improve dimensional accuracy, and reduce the amount of time for users to design and decorate personalized products on a surface (such as a wall, a door, etc.), user 70, 71 can use the wireless device 61 or the computer device 60 installed with a software application provided by the server 32. Referring to FIGS. 3A, 3B, and 4, a user first places an anchor 200 on a wall 210 on which personalized products are to be placed or hung for decoration (step 410). The anchor 200 can be placed in or near a display area 220 on the wall 210. The wall 210 can include areas that are not useable by the display area 220 for displaying personalized products: for example, objects such as a window 230, a door (not shown), a stair case (not shown), etc. In addition, furniture 240 can also block certain portion the wall 210.

It should be noted that although examples are described to create and place personalizable products on a wall surface, the present invention is applicable to other decoratable surfaces in a home, business or public environment, which include surfaces oriented along vertical, horizontal, or other directions.

The primary function of the anchor 200 to provide a length scale for the display area 220 and the personalized products to be selected to be placed in the display area 220 for decoration. The anchor 200 can be implemented using objects of known fixed dimensions such as a square post-it paper (3″ by 3″), a letter size paper (8.5″×11″), a coin, an electronic device (e.g. an iPhone), a ruler, or a sheet of paper with a ruler (e.g. 4″ long) drawn or printed on it. Depending on the weight and the configuration, the anchor 200 can be attached to the surface of the wall 210 (by adhesive or hanging off a nail) or placed on a shelf or table leaning against the wall 210 with a known fixed dimension of the anchor 200 positioned parallel to the surface of the wall 210.

In some embodiments, the user can receive a physical anchor in mail from an image service provider such as Shutterfly, Inc. The physical anchor can have a self-adhesive backing that allows it to be adhered to the wall surface. The user can also receive, from an image service provider, a digital file of an image of the anchor which can be printed to an absolute scale.

Another function of the anchor 200 is to provide a reference point to define the position of the display area 220 on the wall 210. For example, the anchor 200 can define a corner of the display area 220, which can be used as the origin of an x-y coordinate for the display area 220, as shown in FIG. 3A.

Next, an application is launched, under the command of a user, on a computer device 250 (e.g. the wireless device 61 or the computer device 60 in FIG. 2) which is communication with the server 32 (FIG. 2). The computer device 250 can include a mobile device such as a mobile phone or a tablet computer, as well as a laptop computer or a desktop equipped with or connected to a camera. The computer device 250 can also include wearable computer devices such as Google Glass, HoloLens, and virtual reality devices such as Oculus Rift, etc. which allow users to view and edit digital content superimposed on a real environment.

The application uses the camera function of the computer device 250 to capture a live image of the wall 210 and the display area 220, and display them on the computer device 250 (step 415). The live image can include a video recording, or one or more still images. The application on the computer device 250 can display a virtual border 225A around a display area 220A and an anchor 200A in or near the display area 220A. The virtual border 225A can be adjusted by the user by touching, holding, and moving a border line on a touch sensitive screen. The display area 220A and the anchor 200A on the computer device 250 are respectively projected to the display area 220 and the anchor 200 on the wall 210. Similarly, the virtual border 225A on the computer device 250 corresponds to a virtual border 225 around the display area 220 on the wall 210. Other objects such as a window 230A and furniture can also be displayed on the computer device 250.

The application can automatically search and identify the anchor 200 as the anchor 200A on the screen of the computer device 250 (step 420) and infer its physical dimensions (e.g. the size of an iPhone 6s, or a quarter coin in U.S. currency). The known dimensions of the anchor 200A are pre-stored, and are retrieved by the computer device 250 after the anchor 200 is identified on the wall 210. Alternatively, the application can include a function to allow the user to first identify the anchor 200A (step 420) by touching the anchor 200A on the screen. The computer device 250 includes a computer processor that recognizes the image object selected by the user as the anchor 200A. The computer processor automatically detects the boundaries of the anchor 200A, and calculates its width and height in number of pixels using the positions of the boundaries. Alternatively, the application on the computer device 250 can allow the user to enter the dimension of the anchor 200 (for example, for the case of a ruler), or select from one for the most commonly used object as anchor with standard fixed dimensions (e.g. a post-it, a dollar bill, etc.).

Using the dimensions of the anchor 200, the computer processor automatically calculates the dimensions of the display area 220 (step 425). The calculation involves determining the width and the height of the display area 220A in the number of pixels on the computer device. With the dimension ratio of the display area 220A to the anchor 200A obtained, and the real dimensions of the anchor 200 known, the real dimensions of the display area 220 can be accurately calculated by proportional ratios.

Wd=Wa×(Wd′/Wa′) eqn. (1)

in which Wd′ and Wa′ are respectively the widths (or heights) of the display area 220A and anchor 200A in pixels on the computer device 250; Wd and Wa are respectively the real physical widths (or heights) of the display area 220 and the anchor 200 on the real wall 210.

In some embodiments, the application on the computer device 250 automatically suggests the types of personalized products to be used for decoration (step 430), based on the dimensions of the display area 220 as well as the sizes of the personalized products, and logics and rules for aesthetic appearances. The types of personalized products can include canvas print, posters, framed photo or image prints, self-adhesive photo print boards, calendars, banners, photo accessories, as well as decorative wall paper.

In some embodiments, the application on the computer device 250 or the server 32 (FIG. 2) automatically creates designs for the personalized products 260A of the selected personalized product types (step 435) based on the dimensions of the display area, the sizes of the personalized products, and logics and rules for aesthetic appearances. The design includes the number and types of personalized products as well as layouts of the personalized products. The logics and rules take into account not only the overall dimensions (e.g. width, height, etc.) of the display area 220, the dimensions of the collection of personalized products 260A, but also the gaps between the products and margins along the borders of the display area 210. Furthermore, the application on the computer device 250 or the server 32 (FIG. 2) automatically creates designs for individual personalized products, which includes borders, background, design elements, text fonts and colors, and selection of user's photos within individual personalized products, which is also in part based on the dimensions of the display area and the sizes of the personalized products.

In some embodiments, photos, designs, or text are automatically selected from the computer device 250 or in the data storage 34 (FIG. 2) to incorporate in the personalized products in the display area on the surface (step 440). The selections of the photos for the personalized products are in part based on the dimensions of the display area, the sizes of the personalized products, and the types of personalized products.

In some embodiments, the selection of personalized product types, design of the personalized products, and photos incorporated in the personalized products can depend on the surface textures, painting as well painting colors of the wall 210 (steps 430 and 435). For example, the computer device 250 or the server 32 (FIG. 2) can calculate the color distributions in the photos, and selecting those photos having color distributions that match the color of the wall 210, or to produce aesthetic contrast against the color of the wall 210.

Optionally, in some embodiments, the application on the computer device 250 allows the user to pick or create a collection of personalized products 260 compatible with the display area 220. The user can also edit photos or personalized product designs that are automatically created by the application and the computer system.

The collection of personalized products 260A can be automatically placed and displayed within a virtual border 227B of the display area 210A on the computer device 250, based on the logics and rules for aesthetic appearances (step 445). The collection of personalized products 260A can also be manually placed on the wall by the user.

In some embodiments, a plurality of personalized product layouts can be stored in a computer storage (e.g. the data storage 34 in FIG. 2 or the computer device 250) for display areas with common sizes and aspect ratios. For each of the common display area in size and shape, there can be a plurality of layouts for possible personalized products. The computer processor can retrieve these layouts in response to the calculated dimensions and aspect ratio of the display area 220 and automatically selects one or more layouts to recommend to the user (step 445). The library of layouts can also be used for recommending particular personalized products to be used in decorating the specific display area 220 (step 430).

One advantageous feature of the disclosed method is that the application on the computer device 250 allows the user to preview how the personalized products look like on the computer device 250 in a digital environment that include both virtual objects and representations of physical objects from the real environment. Once the collection of personalized products 260A is placed in the display area 220A, the user can preview the appearance of the collection of personalized products 260A in the realistic environment (with the correct dimensions, and the objects such as furniture, doors, windows, and staircase, etc.). The user can adjust the position of the collection of personalized products 260, change the photos in the collection of personalized products 260A, or change the types of the personalized products 260A in the layout of the display area 220 on the wall 210 (step 450) to achieve the best decorative appearance. The user can zoom in to look at details of the personalized products and zoom out to look at the display effect of the entire surface of the wall 210A in the environment.

Once a satisfactory set of personalized products 260A has been selected for the display area 229 on the wall 210, a project can be saved on the computer device 250 and in a networked computer storage over a computer network (e.g. the data storage 34 in FIG. 2). The project can be optionally previewed and edited on different computer devices (step 455) in communication with the networked computer storage. For example, referring to FIG. 3B, the project can be displayed in a web user interface (e.g. a web browser) on a desktop computer 300 or a mobile app running on a tablet computer in communication with the networked computer storage. The personalized products 260B can be displayed in the display area 220B defined by a virtual border 225B on a wall 210B. Window 230B, furniture, door, and staircase can also be displayed on the desktop computer 300. Since the anchor has fulfilled its roles, it is optional whether an anchor is displayed on the desktop computer 300. The user can adjust the positions and alignments of the collection of personalized products 260B, change the pictures in the collection of personalized products 260B, or change product types.

Once the project is finalized, the user can order the set of personalized products from image-service providers such as Shutterfly, Inc. The personalized products are manufactured based on the product selections and the designs of the personalized product (step 460). After a user (who can be a second user or the first user) receives the personalized products, the user can place the personalized products using the layouts on a computer device as guidelines (step 465). This computer device can be the same as or a different device from the computer device (250) that captured the image of the display area on the wall. Referring to FIG. 3A, while showing a live picture of the wall 210 and the layout of the collection of personalized products 260A on the computer device in the application (operated by a first user), a (second) user can place one of the physical personalized product on the wall in such a way such that the outline of the physical personalized product coincides with the outlines of personalized product 260A in the layout on the computer device 250. Positioning all physical personalized products in such a way assures maintaining the aesthetic effect of the personalized products as originally designed.

In some embodiments, a photo of the display area on a surface can be captured by a first computer device. The designs of photos products and layout of these personalized products on the wall can be conducted on a different computer device using the photo of the display area as a background. It should be noted that although examples are described to create and place personalizable products on a wall surface, the present invention is applicable to other decoratable surfaces in a home, business or public environment, which include surfaces oriented along vertical, horizontal, or other directions.

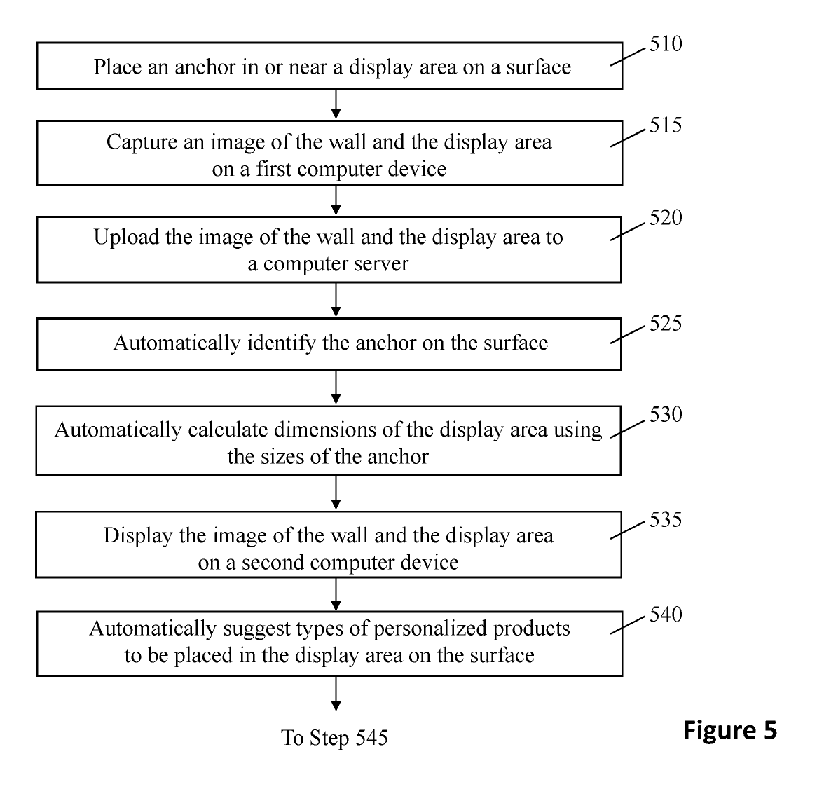

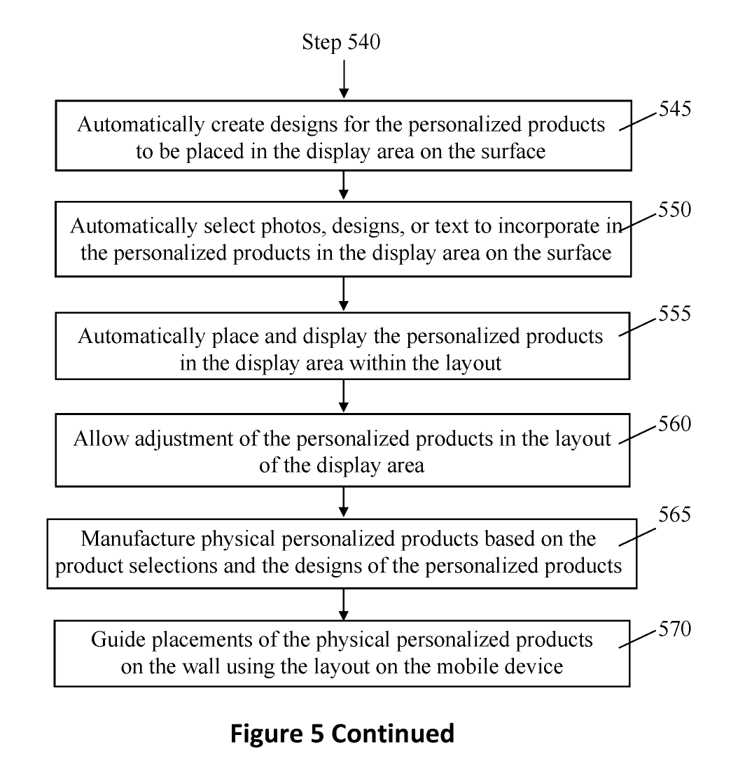

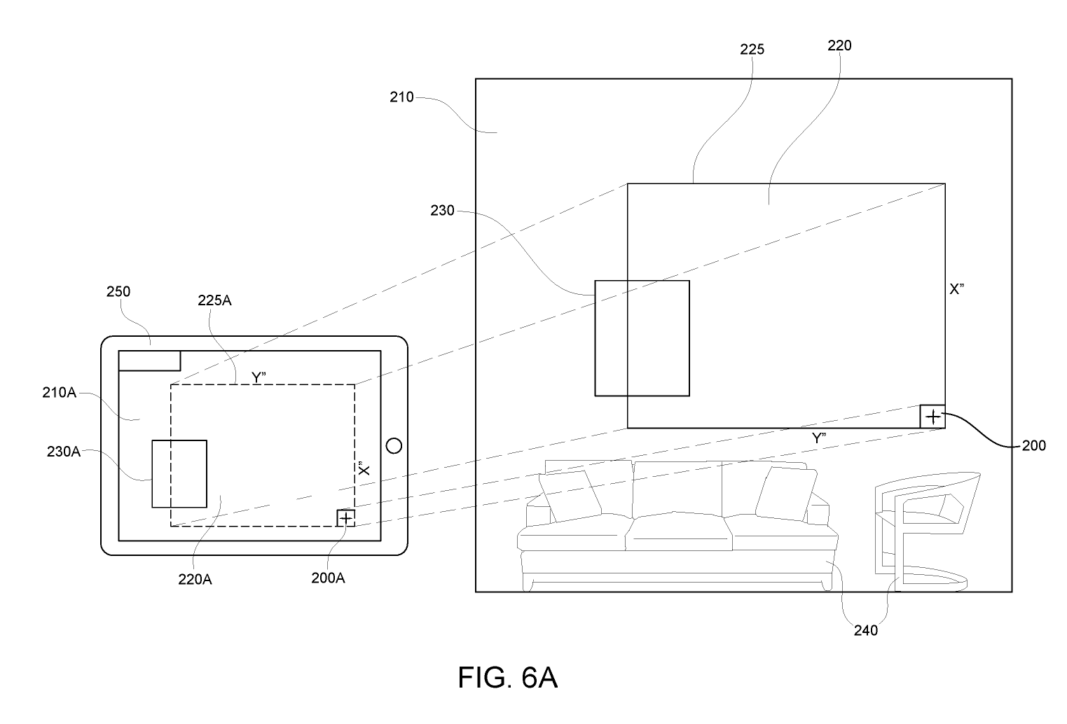

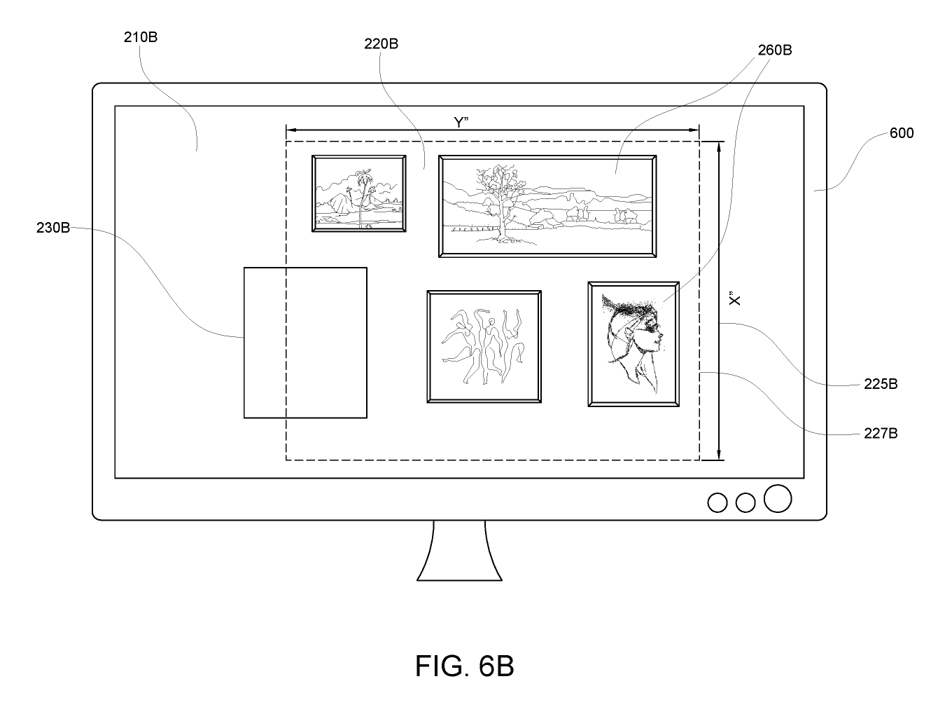

Referring to FIGS. 2, 5 and 6A, a user first places an anchor 200 on a wall 210 on which personalized products are to be placed or hung for decoration (step 510). The anchor 200 can be placed in or near a display area 220 on the wall 200. The wall 210 can include areas that are not useable by the display area 220 for displaying personalized products: for example, objects such as a window 230, a door (not shown), a stair case (not shown), etc. In addition, furniture 240 can also block certain portion the wall 210. As described above, the primary function of the anchor 200 to provide a length scale for the display area 220 and the personalized products to be selected to be placed in the display area 220 for decoration. Another function of the anchor 200 is to provide a reference point to define the position of the display area 220 on the wall 210. For example, the anchor 200 can define a corner of the display area 220, which can be used as the origin of an x-y coordinate for the display area 220, as shown in FIG. 6A.

Next, an application is launched, under the command of a user, on a computer device 250 (e.g. the wireless device 61 or the computer device 60 in FIG. 2) which is communication with the server 32 (FIG. 2). The computer device 250 can include a mobile device such as a mobile phone or a tablet computer, as well as a laptop computer or a desktop equipped with or connected to a camera. The computer device 250 can also include wearable computer devices such as Google Glass, HoloLens, and virtual reality devices such as Oculus Rift, etc. which allow users to view and edit digital content superimposed on a real environment.

The application uses the camera function of the computer device 250 to capture an image of the wall 210 and the display area 220 (step 515). The image can include a video recording, or one or more still images, which can be displayed on the computer device 250. The application on the computer device 250 can display a virtual border 225A around a display area 220A and an anchor 200A in or near the display area 220A. The virtual border 225A can be adjusted by the user by touching, holding, and moving a border line on a touch sensitive screen. The display area 220A and the anchor 200A on the computer device 250 are respectively projected to the display area 220 and the anchor 200 on the wall 210. Similarly, the virtual border 225A on the computer device 250 corresponds to a virtual border 225 around the display area 220 on the wall 210. Other objects such as a window 230A and furniture can also be displayed on the computer device 250.

The image of the wall 210 and the display area 220 is next uploaded to servers (32 in FIG. 2) in the network-based imaging service system 10 (FIG. 2) (step 520).

The application on the computer device 250 or the servers 32 can automatically search and identify the anchor 200 as the anchor 200A on the screen of the computer device 250 (step 525) and infer its physical dimensions (e.g. the size of an iPhone 6s, or a quarter coin in U.S. currency). The known dimensions of the anchor 200A are pre-stored, and are retrieved by the computer device 250 or the servers 32 after the anchor 200 is identified on the wall 210. Alternatively, the application can include a function to allow the user to first identify the anchor 200A by touching the anchor 200A on the screen. The computer device 250 includes a computer processor that recognizes the image object selected by the user as the anchor 200A. The computer device 250 or the servers 32 automatically detects the boundaries of the anchor 200A, and calculates its width and height in number of pixels using the positions of the boundaries. Alternatively, the application on the computer device 250 can allow the user to enter the dimension of the anchor 200 (for example, for the case of a ruler), or select from one for the most commonly used object as anchor with standard fixed dimensions (e.g. a post-it, a dollar bill, etc.).

Using the dimensions of the anchor 200, the computer device 250 or the servers 32 automatically calculates the dimensions of the display area 220 (step 530). As described above, the calculation involves determining the width and the height of the display area 220A in the number of pixels in the captured image. The known dimension of the anchor 200A can be stored on the computer device 250 or in a computer storage (e.g. the data storage 34 in FIG. 2) in communication with the servers 32. If the dimensions of the display area 220 are calculated by the computer device 250, these dimensions are uploaded to the servers 32 together with the image of the wall surface and the display area in step 520. The image of the wall surface and the display area and the dimensions of the display area 220 are stored in a networked computer storage over a computer network (e.g. the data storage 34 in FIG. 2).

In some embodiments, referring to FIGS. 2, 5-6B, an image of the wall 210B and the display area 220B with known dimensions 225B is displayed at a user interface on a different computer device 600 in communication with the networked computer storage and the servers 32 (step 535). The image of the wall 210B and the display area 220B are displayed as a background for a layout on which one or more personalized products can be automatically placed by the computer device 600 or servers 32, or manually placed by a user (who can be a second user or the first user). The second computer device 600 can include a desktop computer, a laptop or tablet computer, a mobile device such as a mobile phone, which can be operated using different types of operating systems such as Windows, iOS, and Android. The user interface can include a web browser, mobile applications, etc. A virtual border 227B is displayed around the display area on the computer device 600.

Since the anchor (200A in FIG. 6A) has been identified and used to calculate the dimensions of the display area (220A in FIG. 6A), it is optional whether an anchor is displayed on the computer device 600. In one embodiment, the anchor is removed and is not displayed on the computer device 600.

Other objects displayed can include a window 230B and furniture (not shown) which represent spaces not for displaying personalized products. The computer device 600 can receive the image of the wall 210B and the display area 220B and the dimensions 225B from the networked computer storage and the servers 32.

The network-based imaging service system 10 or an application on the computer device 600 can automatically suggest the types of personalized products to be used for decoration (step 540), based on the dimensions of the display area 220B as well as the sizes of the personalized products, and logics and rules for aesthetic appearances. The types of personalized products can include canvas print, posters, framed photo or image prints, self-adhesive photo print boards, calendars, banners, photo accessories, as well as decorative wall paper.

In some embodiments, the application on the computer device 600 or the server 32 automatically creates designs for the personalized products 260B of the selected personalized product types (step 545) based on the dimensions of the display area, the sizes of the personalized products, and logics and rules for aesthetic appearances. The design includes the number and types of personalized products as well as layouts of the personalized products. The logics and rules take into account not only the overall dimensions (e.g. width, height, etc.) of the display area 220, the dimensions of the collection of personalized products 260B, but also the gaps between the products and margins along the borders of the display area 210B. Furthermore, the application on the computer device 600 or the server 32 automatically creates designs for individual personalized products, which includes borders, background, design elements, text fonts and colors, and selection of user's photos within individual personalized products, which is also in part based on the dimensions of the display area and the sizes of the personalized products.

In some embodiments, photos, designs, or text are automatically selected by the user on the computer device 250 or 600 or from the data storage 34 to incorporate in the personalized products in the display area on the wall (step 550). The selections of the photos for the personalized products are in part based on the dimensions of the display area, the sizes of the personalized products, and the types of personalized products.

In some embodiments, the selection of personalized product types, design of the personalized products, and photos incorporated in the personalized products can depend on the surface textures, painting as well painting colors of the wall 210 (steps 540 and 545). For example, the computer device 600 or the server 32 can calculate the color distributions in the photos, and selecting those photos having color distributions that match the color of the wall 210, or to produce aesthetic contrast against the color of the wall 210.

Optionally, the server 32 or the application on the computer device 600 allows the user to pick or create one or more personalized products 260B compatible with the display area 220. The user can also edit photos or personalized product designs that are automatically created by the application and the computer system.

The collection of personalized products 260B is automatically placed and displayed within the virtual border 227B of the display area 220B on the computer device 600, based on the logics and rules for aesthetic appearances (step 555). The collection of personalized products 260B can also be manually placed based on the wall by the user.

In some embodiments, a plurality of personalized product layouts can be stored in a computer storage 34 or on the computer device 600 for common display areas (sizes and aspect ratios). For each of the common display areas in size and shape, there can be a plurality of layouts for possible personalized products. The computer processor can retrieve these layouts in response to the calculated dimensions and aspect ratio of the display area 220 and automatically selects one or more layouts to recommend to the user (step 555). The library of layouts can also be used for recommending particular personalized products to be used in decorating the specific display area 220 (step 540).

One advantageous feature of the disclosed method is that the application on the computer device 250 allows the user to preview how the personalized products look like on the computer device 250 in a digital environment that include both virtual objects and representations of physical objects from the real environment. Once the collection of personalized products 260B is placed in the display area 220B, the user can preview the appearance of the collection of personalized products 260B in the realistic environment (with the correct dimensions, and the objects such as furniture, doors, windows, and staircase, etc.). The user can adjust the position of the collection of personalized products 260, change the photos in the collection of personalized products 260B, or change the types of the personalized products 260B in the layout of the display area 220 on the wall 210 (step 560) to achieve the best decorative appearance. The user can zoom in to look at details of the personalized products and zoom out to look at the display effect of the entire surface of the wall 210B in the environment.

Once the project is finalized, the user can order the set of personalized products from image-service providers such as Shutterfly, Inc. The personalized products are manufactured based on the product selections and the designs of the personalized product (step 565). After the user receives the personalized products, the user can place the personalized products using the layouts on a mobile device as guidelines (step 570). The mobile device can be the same as or a different device (e.g. a different mobile phone) from the first computer device that captured the image of the display area on the surface. While showing a live picture of the wall and the layout of the collection of personalized products on the computer device in the application (operated by a first user), outlines of the personalized products are displayed in the display area on the mobile device. A (second) user can place one of the physical personalized products on the wall to match the outline of the physical personalized product to the outline of the personalized product in the layout on the mobile device. Positioning all physical personalized products in such a way assures the aesthetic effect of the personalized products as originally designed.

It should be understood that the presently disclosed systems and methods can be compatible with different devices and personalized products or applications other than the examples described above. The network-based system can be implemented with different hardware or software configurations without deviating from the spirit of the present invention. User behaviors, product types, user categories, and category specifications are not limited to the described examples while still compatible with the disclosed invention.

What is claimed is:

1. A method for automatically creating a design for a collection of personalized products in a display area, comprising:
capturing an image of a display area and an anchor on a surface by a first computer device, wherein the anchor has a known dimension;
uploading the image of the display area from the first computer device to a server;
automatically identifying the anchor on the surface;
automatically calculating a dimension ratio of the display area to the anchor in the image;
automatically calculating dimensions of the display area using the known dimension of the anchor and the dimension ratio of the display area and the anchor in the image;
displaying in the display area on a second computer device in communication with the server; and
displaying one or more personalized products over the display area on the second computer device.

2. The method of claim 1, further comprising:
automatically suggesting one or more personalized products to be placed in the display area based on the dimensions of the display area and sizes of the personalized products; and
displaying the collection of personalized products in the display area on the second computer device.

3. The method of claim 1, wherein the step of displaying in the display area on a second computer device comprises removing the anchor from the image, wherein the anchor is not displayed in or next to the display area on the second computer device.

4. The method of claim 1, wherein the known dimension is stored on the first computer device or a computer storage in communication with the server.

5. The method of claim 1, wherein the known dimension of the anchor is received from a user by the first computer device.

6. The method of claim 1, further comprising:
displaying a virtual border around the display area on the second computer device, wherein the one or more personalized products are displayed within the virtual border on the second computer device.

7. The method of claim 1, further comprising:
automatically suggesting types for the personalized products to be placed in the display area based on the dimensions of the display area and sizes of the personalized products.

8. The method of claim 7, wherein the types of the personalized products to be placed in the display area are automatically selected in part based on a color or a texture of the surface.

9. The method of claim 1, further comprising:
automatically creating designs of the personalized products to be placed in the display area in part based on the dimensions of the display area and sizes of the personalized products.

10. The method of claim 9, wherein the designs of the personalized products is automatically created in part based on a color or a texture of the surface.

11. The method of claim 1, further comprising:
automatically selecting photos, designs, or text to be incorporated in the personalized products to be placed in the display area.

12. The method of claim 11, wherein the photos to be incorporated in the personalized products is automatically selected in part based on a color or a texture of the surface.

13. The method of claim 1, further comprising:
storing a layout of the collection of personalized products in the display area on the second computer device or a computer storage in communication with the server.

14. The method of claim 1, further comprising:
manufacturing physical personalized products based on the one or more of personalized products displayed over the display area.

15. The method of claim 14, further comprising:
guiding placements of the physical personalized products on the surface comprising the steps of:
capturing a live image of the display area on the surface using a mobile computer device;
displaying the layout of the one or more personalized products in the display area on the mobile computer device; and
placing the one or more physical personalized products in the display area on the surface according to the layout of the one or more personalized products on the mobile computer device.

16. The method of claim 15, further comprising:
displaying an outline for each of the one or more personalized products in the display area on the mobile computer device; and
placing one of the one or more physical personalized products such that an outline of the one of the one or more physical personalized products matches the outline for each of the one or more personalized products in the display area on the mobile computer device.

17. The method of claim 1, the known dimension is a width of the anchor, wherein a width of the display area is automatically calculated using the width of the anchor multiplied by the dimension ratio of the display area to the anchor in the image.

18. The method of claim 1, wherein the known dimension is a height of the anchor, wherein a height of the display area is automatically calculated using the height of the anchor multiplied by the dimension ratio of the display area to the anchor in the image.

19. A method for guiding placements of the physical personalized products on a surface comprising:
storing a design for one or more personalized products in a display area on a surface, wherein the design for one or more personalized products includes a layout of the one or more personalized products in the display area;
capturing a live image of the display area on the surface using a mobile computer device;
displaying the layout of the one or more personalized products in the display area on the mobile computer device; and
guiding placements of one or more physical personalized products in the display area on the surface according to the layout of the one or more personalized products on the mobile computer device.

20. The method of claim 1, further comprising:
displaying an outline for each of the one or more personalized products in the display area on the mobile computer device; and
placing one of the one or more physical personalized products such that an outline of the one of the one or more physical personalized products matches the outline for each of the one or more personalized products in the display area on the mobile computer device.
